(19) United States
(12) Patent Application Publication
(10) Pub. No.: US 2019/0375177 A1
(43) Pub. Date: Dec. 12, 2019

(54) UNIVERSAL TRASH COMPACTING MECHANISM FOR TRASH RECEPTACLES

(71) Applicant: Louis J. Basso, Chesterfield, MO (US)

(72) Inventor: Louis J. Basso, Chesterfield, MO (US)

(21) Appl. No.: 16/006,231

(22) Filed: Jun. 12, 2018

(51) Int. Cl. B30B 1/18; B30B 15/06; B65F 1/14

(52) U.S. Cl. CPC B30B 1/181; B30B 15/062; B65F 2210/1443; B65F 1/1405; B30B 1/186

(57) ABSTRACT

In an example embodiment, a universal compacting mechanism can be selectively engaged with an existing trash receptacle of any size or shape. The universal compacting mechanism comprises a housing assembly, a motor, a power source, a plate assembly, and an attachment mechanism. The housing assembly includes a threaded rod extending along at least part of the longitudinal axis of the housing assembly. The motor engages with the threaded rod for rotating the threaded rod about the longitudinal axis of the threaded rod. The power source is electrically connected to the motor for providing power to the motor. The plate assembly includes a compaction plate. The plate assembly is engaged with the threaded rod such that rotation of the threaded rod causes a raising or lowering of the plate assembly. The attachment mechanism selectively engages the trash compactor to an existing trash receptacle of any size or shape.

### FIELD OF INVENTION

The present invention relates generally to a portable trash compactor. More particularly, the present invention relates to a trash compactor that can be selectively engaged with existing trash receptacles to compact trash therein.

### BACKGROUND OF INVENTION

Trash compaction is the process of compacting trash and waste, thereby reducing it in size. For example, garbage compactors compress trash to allow more garbage storage in the same space. Such trash compaction is often beneficial, both for those disposing of the trash and for the company collecting it. Trash collection companies often bill according to volume, and compaction allows for more garbage to fit in the same space. Further, compacting trash allows more garbage to fit inside a collection vessel or vehicle, meaning fewer trips to a dump or fewer changes of a trash bag by personnel. By some estimates, uncompacted trash occupies up to twenty times more space than compacted waste. Trash pickup costs are thereby reduced, and fewer or smaller dumpsters may be used. Additionally, the use of up to 20 trash bags/liners can potentially be avoided.

Trash compactors are available for both residential and commercial use. However, commercial units are generally too large and TOO expensive for residential use and in public facilities, such as public bathrooms, sports arenas, restaurants, and other places where there is voluminous use of paper towels or the like. Residential compactors are often expensive stand-alone units. As nearly all homes, public restrooms, and office buildings, etc., already have multiple trash receptacles, it can be inefficient undesirable to buy a separate stand-alone trash compactor unit.

Thus, there is an ever increasing need for a universal compaction device that can convert any existing receptacle into a trash compactor.

### SUMMARY OF THE INVENTION

In an example embodiment, a universal compacting mechanism can be selectively engaged with an existing trash receptacle. The universal compacting mechanism comprises a housing assembly, a motor, a power source, a plate assembly, and an attachment mechanism. The housing assembly includes a threaded rod extending along at least part of the longitudinal axis of the housing assembly. The motor engages with the threaded rod for rotating the threaded rod about the longitudinal axis of the threaded rod. The power source is electrically connected to the motor for providing power to the motor. The plate assembly includes a compaction plate (or “fin”) that is geometrically shaped to travel inside the trash receptacle. The plate assembly is engaged with the threaded rod such that rotation of the threaded rod causes a raising or lowering of the plate assembly. The attachment mechanism selectively engages the universal compacting mechanism to an existing trash receptacle of any shape or size. The plate assembly is designed to fit inside the receptacle in which the universal compacting mechanism is to be used. The compaction fin of the plate assembly may include a through-hole to allow trash to be thrown into the receptacle.

When the trash inside the receptacle reaches a certain point inside the receptacle, the plate assembly is automatically actuated to compress the contents of the receptacle.

### DESCRIPTION OF THE DRAWINGS

For a better understanding of the various embodiments of the present invention, reference may be made to the accompanying drawings in which:

FIG. 1 a perspective view of a universal compacting mechanism according to an example embodiment;

FIG. 2 is a front elevation view of the universal compacting mechanism of FIG. 1.

FIG. 3 is a top plan view of the universal compacting mechanism of FIG. 1.

FIG. 3A is a top plan view of an alternative universal compacting mechanism.

FIG. 4A is a side elevation view of a portion of the universal compacting mechanism of FIG. 1 as shown in a second position.

FIG. 4B is a side elevation partial view of the portion of the universal compacting mechanism of FIG. 4A as shown in a first position.

FIG. 5 is a partial perspective view of an attachment mechanism of the universal compacting mechanism of FIG. 1.

While the disclosure is susceptible to various modifications and alternative forms, a specific embodiment thereof is shown by way of example in the drawings and will herein be described in detail. It should be understood, however, that the drawings and detailed description presented herein are not intended to limit the disclosure to the particular embodiment disclosed, but to the contrary, the intention is to cover all modifications, equivalents, and alternatives falling within the spirit and scope of the present disclosure as defined by the appended claims.

### DETAILED DESCRIPTION OF THE INVENTION

The invention will now be described with reference to the drawing figures, in which like reference numerals refer to like parts throughout. For purposes of clarity in illustrating the characteristics of the present invention, proportional relationships of the elements have not necessarily been maintained in the drawing figures.

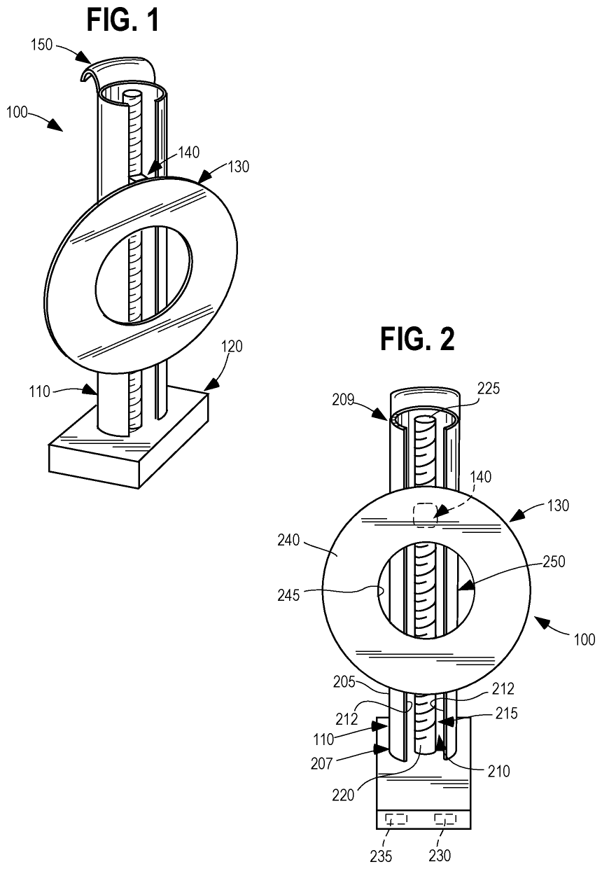

Referring to the drawings, FIG. 1 illustrates an example embodiment of a universal compacting mechanism 100, which generally includes a housing assembly 110, a motor assembly 120, a compacting plate assembly 130, a guide mechanism 140, and an attachment mechanism 150. As can be seen in FIG. 1, the attachment mechanism 150 is used for securing the universal compacting mechanism 100 to any trash receptacle. The guide mechanism 140 connects the compacting plate assembly 130 with the housing assembly 110, while the motor assembly 120 drives movement of the guide mechanism 140 (and thereby the compacting plate assembly 130).

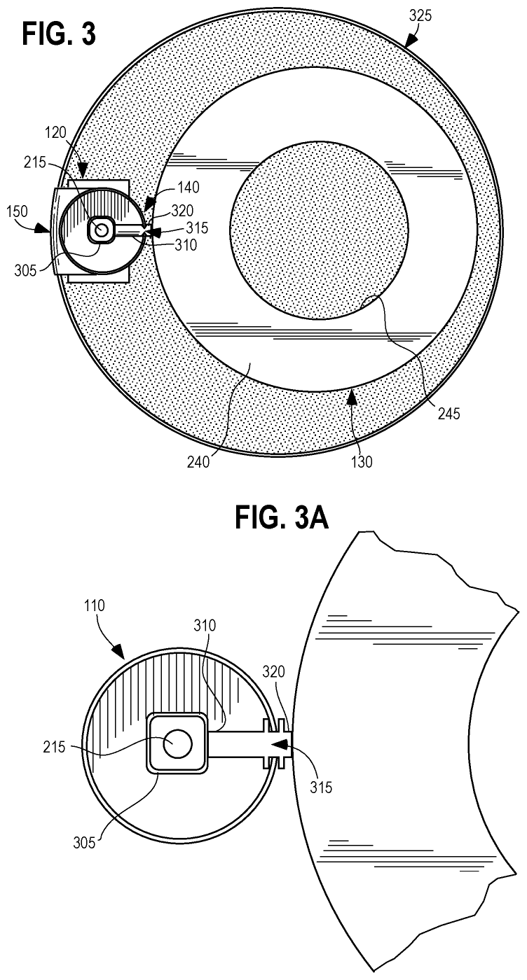

FIG. 2 illustrates a front elevation view of the universal compacting mechanism 100 of FIG. 1. As can be seen, the housing assembly 110 includes a housing 205 that extends from a bottom end 207 to a top end 209. As shown, the housing 205 may include a gap 210 positioned between opposing edges 212 of the housing 205. Thus, the housing 205 may be generally circular or elliptical in transverse cross-section (although other shapes are envisioned), except for the gap 210. The gap 210, and thus the opposing edges 212, may run most or all of the longitudinal length of the housing 205 from the bottom end 207 to the top end 209 of the housing 205. The gap 210 in FIG. 2 is shown as being larger than is standard, to assist with viewing the internal mechanisms of the housing assembly 110. More accurate sizing of the gap 210 and positioning of the opposing edges 212 are shown in FIG. 3. The bottom end 207 of the housing 205 may be engaged with the motor assembly 120, although other positions for the motor assembly are envisioned. The motor assembly 120 is illustrated as being generally rectangular, although other shapes (including but not limited to cylindrical) are envisioned.

Positioned within the housing 205 may be a threaded rod 215. The threaded rod 215, like the housing 205, extends from a bottom end 220 to a top end 225. When structured with the motor assembly 120 at the bottom end 207 of the housing 205, the bottom end 220 of the threaded rod 215 is also engaged with the motor assembly 120. The motor assembly 120 includes a motor 230 for driving rotation of the threaded rod 215 at the bottom end 220 of the threaded rod 215. Other locations and configurations of the motor assembly 120 may drive rotation of the threaded rod 215 at other locations there-along. A power source 235 electrically connected with the motor 230 provides power to the motor 230. The power source 235 may be any known power sources, such as batteries, a standard plug for a wall outlet, or the like. A recharge port may be positioned on the motor assembly 120 for recharging the power source 235 where the power source 235 includes rechargeable batteries. The power source 235 may also provide electrical power to any sensors, discussed above.

The plate assembly 130 is connected to the threaded rod 215 via the guide mechanism 140, as will be discussed in detail below. The plate assembly 130 includes a compaction fin 240. As shown in FIG. 2, the compaction fin 240 is shown in a first position in which the fin 240 extends substantially parallel with the longitudinal axis of the housing assembly 110. As will be discussed in detail below, in the first position, the compaction fin 240 is positioned out of the way to allow normal use of a trash receptacle. In the example embodiment shown in FIG. 2, the compaction fin 240 includes an inner edge 245 that defines a through-hole 250. Such a through-hole 250 may be omitted where the compaction fin 240 is designed to move to the first position when not in use, such that the compaction plate is generally uniform. However, in embodiments where the first position is omitted (as discussed in detail below), the through-hole 250 may be present to allow trash to be deposited into the trash receptacle through the through-hole 250.

FIG. 3 illustrates a top plan view of the universal compacting mechanism 100, as positioned within an example round trash receptacle. However, it will be understood that the universal compacting mechanism 100 could be used with different trash receptacles of various sizes and shapes. As can be seen, the attachment mechanism 150 extends over the rim of the trash receptacle, to lock the universal compacting mechanism 100 in place thereon. The housing assembly 110 then extends down into the trash receptacle along a side of the trash receptacle. As generally circular trash receptacle is shown, it follows that a generally circular compaction fin 240 is shown. However, differently shaped compaction fin 240 may be used to coordinate with differently shaped trash receptacles (e.g., circular, square, rectangular, oval, etc.), as will be understood.

As can be seen, the plate assembly 130 is connected to the threaded rod 215 via the guide mechanism 140. The guide mechanism 140 includes a threaded hole 305 in a proximal portion 310 that engages with the threads of the threaded rod 215. The proximal portion 310 narrows in width at a notched portion 315, which then extends to a distal portion 320. The notched portion 315 is positioned in the gap 210 between the opposing edges 212 of the housing 205. The opposing edges 212 are preferably positioned such that the gap 210 is smaller than the width of either the distal portion 310 or the proximal portion 320. Thus, only the notched portion 315 is capable of fitting therethrough. This allows the opposing edges 212 to function as guide rails for the guide mechanism 140 up and down the length of the housing assembly 110. The proximal portion 310 may extend into the housing 110 past the threaded rod 215 to the back of the housing 110, and may be tapered to allow smooth travel and further stability as the guide mechanism 140 travels up and down the gap 210. The distal portion 320 extends past the opposing edges 212 where it connects to the plate assembly 130, either fixedly or hingedly as described earlier. In some embodiments, the proximal portion 310 may not include a through-hole 305, but may instead connect to a nut (not shown) engaged with the threaded rod 215. Such structure will be understood to be within the meaning of a threaded hole within the proximal portion.

In operation, the motor 230 turns the threaded rod 215. When the threaded rod 215 is rotated in a clockwise direction, the proximal portion 310 is prevented from rotating with the threaded rod 215 by the engagement of the notched portion 215 with one of the opposing edges 212. When the threaded rod 215 is rotated in a counterclockwise direction, the proximal portion 310 is again prevented from rotating with the threaded rod 215 by the engagement of the notched portion 215 with the other of the opposing edges 212. Thus, the proximal portion 310 is kept in a single orientation, which in turn causes the guide mechanism 140 (and thereby the plate assembly 150) to move up and down the threaded rod 215 through the threaded hole 305 as the threaded rod 215 turns. Movement of the guide mechanism 140 up and down the threaded rod 215 causes movement of the plate assembly 130 to compact trash in the trash receptacle.

In an alternative embodiment, the gap 210 may be sufficiently wide for a modified notched portion to have the same width as the proximal and distal portions 310, 320, such that it is not actually notched as shown in FIG. 3. However, such a modified notched portion could still function as described above, abutting the opposing edges 212 to prevent the guide mechanism 140 from rotating as the threaded rod 215 turns. It will be understood that the section of the guide mechanism 140 that engages with the opposing edges 212 could take many forms. For example, as that shown in FIG. 3A, and receiver portion 315A is shown between the proximal and distal portions 310, 320. The receiver portion 315A actually receives the opposing edges 212 as shown in FIG. 3A.

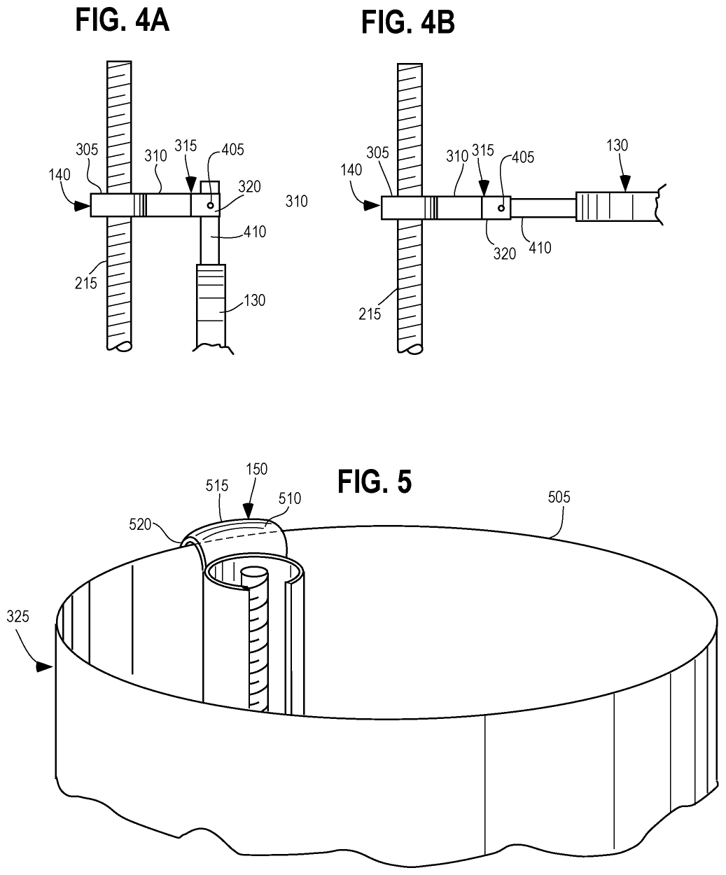

FIGS. 4A and 4B illustrate the first position (mentioned above) and second position of the plate assembly 130. In the first position as shown in FIG. 4A, the compaction fin 240 of the plate assembly 130 extends downwardly parallel with the longitudinal axis of the threaded rod 215 (similar to the position shown in FIG. 2). In this position, the plate assembly 130 has been moved out of the way of standard use of the trash receptacle. In FIG. 4B, the compaction fin 240 of the plate assembly 130 extends outwardly, perpendicular with the longitudinal axis of the threaded rod 215 (similar to the position shown in FIG. 3). In this position, when moved downwardly, the compaction fin 240 can compact trash within a trash can.

Movement between the first and section positions may be permitted in many known ways. As shown in FIGS. 4 and 5, in a non-limiting example, the distal portion 320 may include a hinge 405 that hingedly connects to a flange 410. The hinge 405 allows the flange 410 and the plate assembly 130 to pivot with respect to the rest of the guide mechanism 140, between the first and second positions. Movement between the first and section positions may be also be caused in many known ways. As a non-limiting example, a wire (not shown) may be connected to the flange 410, such that when the guide mechanism 140 moves downwardly, the wire begins to exert an upward force on the flange 410. This upward force would pull the flange 410 (and thus the plate assembly 130) from the first position to the second position. Similarly, when raised back up, the wire would lose tension and allow the flange 410 (and thus the plate assembly 130) to drop back from the second position to the first position. Other structures are also envisioned, such as camming or the like.

It should be understood that the ability to move between the first and second positions is optional. In structures that include this functionality, the compaction fin 240 may or may not include a through-hole 250. The ability to move to the first position provides a method for user to deposit trash into the trash receptacle without the use of the through-hole 250. However, in structures that do not include this functionality, the compaction fin 240 preferably includes the through-hole 250. Without the ability to move from the second position to the first position, the through-hole 250 may be the best method for depositing trash into the trash receptacle, given that the plate assembly 130 would remain in the second position.

When viewed in its second position, the compaction fin 240 may slope downwardly as it extends radially inwardly toward its inner edge 245. This may allow trash or other materials to naturally slide down through the through-hole 250 and into the trash receptacle. Additionally, one or more sensors may be used to determine when trash has piled up within the trash receptacle sufficiently to warrant usage of the plate assembly 130. Such sensors may be infrared or the like, as would be known in the art. In an example embodiment, one or more such sensors may be positioned in a cap (not shown), and such cap may be engaged with the top end 209 of the housing 205, as well as top end 225 of the threaded rod 215. The cap may extend beyond housing 205 to position such a sensor for viewing downwardly into a receptacle. Similarly, as the motor 230 drives the plate assembly 130 to compact trash, the same sensor or a different sensor may determine when the trash has been sufficiently compacted. For example, a sensor may detect when more than a predetermined amount of torque is required to further compress the trash. At that point, the motor may be instructed to reverse. The compaction level may be stored in an onboard electronic memory, such that universal compacting mechanism 100 knows to stop future compactions at that point or earlier. This data can be reset when the trash receptacle is emptied.

Additionally, it will be understood that structures other than threaded rod 215 may be used for moving the plate assembly 130 vertically along the housing 205. For example, hydraulics could be used, or a chain drive assembly, or various types of gearing, or a track, or the like may all be used instead of or in addition to the threaded rod 215.

FIG. 5 illustrates an example embodiment of an attachment mechanism 150. The attachment mechanism 150 secures the universal compacting mechanism 100 to a trash receptacle 505. In the embodiment shown in FIG. 5, the attachment mechanism may be a clip extending from the back of the housing 205. The clip may have an upward portion 510 that extends up and over the top of the trash receptacle 505, a top portion 515, and a downward portion 520 that extends downwardly outside of the trash receptacle 505. A friction fit between the upward portion 510, the downward portion 520, and the trash receptacle 505 may hold the universal compacting mechanism 100 in place. Other structures are also envisioned, such as other securement structures like magnets or bolts or clips or the like. Alternatively, a generally Z-shaped attachment mechanism 150 could be used for use with receptacles that have lids on them, as would be understood.

From the foregoing, it will be seen that the various embodiments of the present invention are well adapted to attain all the objectives and advantages hereinabove set forth together with still other advantages which are obvious and which are inherent to the present structures. It will be understood that certain features and sub-combinations of the present embodiments are of utility and may be employed without reference to other features and sub-combinations. Since many possible embodiments of the present invention may be made without departing from the spirit and scope of the present invention, it is also to be understood that all disclosures herein set forth or illustrated in the accompanying drawings are to be interpreted as illustrative only and not limiting. The various constructions described above and illustrated in the drawings are presented by way of example only and are not intended to limit the concepts, principles and scope of the present invention.

As is evident from the foregoing description, certain aspects of the present invention are not limited by the particular details of the examples illustrated herein, and it is therefore contemplated that other modifications and applications, or equivalents thereof, will occur to those skilled in the art. The terms “having” and “including” and similar terms as used in the foregoing specification are used in the sense of “optional” or “may include” and not as “required.”

Many changes, modifications, variations and other uses and applications of the present constructions will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. A universal compacting mechanism for engagement with a trash receptacle, the universal compacting mechanism comprising:
a housing assembly including a threaded rod extending along at least part of a longitudinal axis of the housing assembly;
a motor engaged with the threaded rod for rotating the threaded rod about a longitudinal axis of the threaded rod;
a power source electrically connected to the motor for providing power to the motor;
a plate assembly including a compaction plate, the plate assembly being engaged with the threaded rod such that rotation of the threaded rod in a first direction causes movement of the plate assembly along the longitudinal axis of the threaded rod toward a top of the threaded rod, and rotation of the threaded rod in a second direction causes movement of the plate assembly along the longitudinal axis of the threaded rod toward a bottom of the threaded rod; and
an attachment mechanism for selectively engaging the trash compactor to a said trash receptacle.

2. The universal compacting mechanism of claim 1 further including a guide mechanism connecting the plate assembly with the threaded rod.

3. The universal compacting mechanism of claim 2 wherein the guide mechanism includes:
a proximal portion containing a threaded through-hole therein, the threaded through-hole being engaged with the threaded rod,
a notched portion extending from the proximal portion, and
a distal portion extending from the notched portion, wherein the distal portion is engaged with the plate assembly.

4. The universal compacting mechanism of claim 3 wherein the housing assembly includes a housing at least partially surrounding the threaded rod, the housing having a longitudinal gap separating opposing edges of the housing,
wherein the notched portion of the guide mechanism is positioned in the gap proximate the opposing edges.

5. The universal compacting mechanism of claim 2 wherein the guide mechanism includes a hinge for allowing the plate assembly to selectively move between a first position and a second position.

6. The universal compacting mechanism of claim 5 wherein the compacting plate is a generally uniform.

7. The universal compacting mechanism of claim 3 wherein the guide mechanism further includes a hinge at the distal portion, and a flange engaged with the hinge, the flange engaging past the distal portion to engage with the plate assembly, said flange and hinge allowing the plate assembly to selectively move between a first position and a second position.

8. The universal compacting mechanism of claim 2 wherein the compaction plate includes a through-hole extending therethrough defined by an inner edge.

9. The universal compacting mechanism of claim 8 wherein the compaction plate radially inwardly slopes downwardly toward its inner edge.

10. The universal compacting mechanism of claim 1 further including a sensor for signaling the motor to rotate the threaded rod, thereby moving the plate assembly, based on a level of trash within a said trash receptacle.
